(19) United States
(12) Patent Application Publication
(10) Pub. No.: US 2017/0289666 A1
(43) Pub. Date: Oct. 5, 2017

(54) AUDIO HEADSET, IN PARTICULAR FOR THE PRACTICE OF SPORT

(71) Applicant: PARROT DRONES, Paris (FR)

(72) Inventors: Margot Pejaudier, Paris (FR); David Tea, Lognes (FR)

(21) Appl. No.: 15/465,140

(22) Filed: Mar. 21, 2017

(30) Foreign Application Priority Data
Apr. 1, 2016 (FR) 1652855

(51) Int. Cl. H04R 1/10

(52) U.S. Cl. CPC H04R 1/1016; H04R 1/105; H04R 1/1058

(57) ABSTRACT

This headset (10) comprises two earphones (12), a central headband (14) and two lateral branches (16). Each branch comprises at a proximal end a link (20) articulated with the respective end of the central headband (14), providing at least one pivotal degree of freedom. The earphone is mounted, preferably rigidly, on the distal end of the branch. Each of the branches also comprises, in a median region, a bearing pad (40) provided, on an internal side, with a bearing face (48) adapted to come into contact with a temporal region of the headset user, so that this bearing face forms there-on a point of contact. Each branch (16) has, in an intermediate region between a proximal end on the central headband side and a distal end on the earphone side, an elastically deformable link (17) providing a torsional degree of freedom, preferably a privileged bending in a particular plane.

The invention relates to the audio headsets, in particular the models adapted to the practice of sport.

An audio headset comprises two earphones linked by a linking element positioned around the head of the headset user, passing either above the head or rear the head (hence surrounding the occipital region).

An example of such an audio headset is the Zik Sport headset, which has recently been presented by the Parrot company, Paris, France. This headset is described in particular in a short article dated Jan. 4, 2015, by Richard Lai, published on Internet and entitled “Parrot Zik Sport headphones do noise cancelling, heart monitoring”, engadget.com, (XP055203575), in an article by Joe Stohlman dated Jan. 9, 2015, also published on Internet and entitled “Parrot Zik Sport Headphones Track your Fitness”, wearables.reviewed.com, (XP055324276), or also in an article by Mario Aguilar dated Apr. 1, 2015, also published on Internet and entitled “Parrot Zik Sport: Maybe the Smartest Athletic Headphones Yet”, gizmodo.com, (XP055324279).

Such a headset comprises two earphones of the intra-aural or intra-concha type, adapted to be introduced inside or near a respective auditory canal of the headset user, a central headband adapted to come in rest on the apex of the headset user's head so as to form thereon a first point of contact with the user's head, and two lateral branches continuing the central headband at each of the ends thereof.

Each of the branches comprises, at a proximal end, a link articulated with the respective end of the central headband. This link provides at least one pivotal degree of freedom about an axis perpendicular to the general plane of the headset. The respective earphone is mounted at the distal end of the branch, the earphones forming at the auditory canal a second and a third point of contact, respectively.

Each of the branches also comprises, in a median region, a respective bearing pad provided, on an internal side of the headset directed towards the user's head, with a bearing face adapted to come into contact with a temporal region of the headset user, so that the bearing faces form at the temple a fourth and a fifth point of contact, respectively.

Such a headset, dedicated in particular to the intensive and prolonged practice of sport, offers the following advantages:
a structure that is lightweight enough to be supported during sport practice with no trouble for the user;
easy adaptation to the individual morphology of the head of each user;
assurance of excellent comfort, even in case of prolonged wearing and with practice of physical activity; and
guarantee of effective holding in place and perfect stability of the headset on the user's head, in particular during sport practice.

Although it gives satisfaction, it has however been observed that the qualities of such a headset would still be improved, in particular at regards the aural comfort and in particular the stress applied to the earphones, and consequently to the auditory canals.

The invention hence aims to propose an audio headset providing a better controlled pressure of the earphones to the auditory canals, for a better comfort in particular in case of prolonged use, while guaranteeing a satisfying insulation against the ambient environment, in particular when the headset is equipped with an active noise reduction system.

The EP 2 892 246 A1 describes a headset comprising earphones of the circumaural type, i.e. each provided with a pad fully surrounding the ear auricle. A wide, flat and flexible headband connects the two earphones and, due to its elasticity, stresses these earphones towards each other, which has for effect to press the pads against the user's temples. For a better adjustment, in addition to a height adjustment on the headband, the earphones are pivotally articulated about an axis perpendicular to the plane of the headband so that the plane of application of the pads relative to the user's head can be varied. But this very particular arrangement, peculiar to a headset with circumaural-type earphones, is not transposable to a headset provided with earphones of the intra-aural or intra-concha type, introduced into or in the vicinity of a respective auditory canal of the user, for which the matter is not to ensure the holding by a pressure applied around the ear auricle via a pad.

Characteristically of the invention, the branches each have, in an intermediate region between a proximal end on the central headband side and a distal end on the earphone side, an elastically deformable link.

According to various advantageous subsidiary characteristics:
each elastically deformable link is located substantially at mid-length of the respective branch;
the earphones are mounted rigidly on the distal ends of the respective branches;
each elastically deformable link has a torsional degree of freedom and at least one flexural degree of freedom;
each elastically deformable link comprises two spaced-apart pieces integral with two branch portions located on either side of the link, and an elastically deformable sleeve anchored on said pieces;
in this latter case, advantageously, each piece and the sleeve have parts of mutual shape cooperation, wherein said pieces may in particular each have the shape of a ring provided with a through-opening, with the elastically deformable link that comprises a bending limitation element extending through said through-openings and the internal space of the sleeve;
this bending limitation element comprises a rod made of a material that is more rigid than that of the sleeve, fixed at one end to one of the rings, a cavity adapted to receive the free end of the rod and limiting the displacements thereof being associated with the other ring, said cavity being in particular adapted to hold the rod at a remote position from a trajectory of passage of electric conductors defined by the rings;
the elastically deformable link comprises means to ensure a privileged bending of said link in a particular plane, wherein these means may in particular comprise a notch formed in an external wall of the sleeve.

An example of implementation of the present invention will now be described, with reference to the appended drawings in which the same references denotes throughout the figures identical or functionally similar elements,

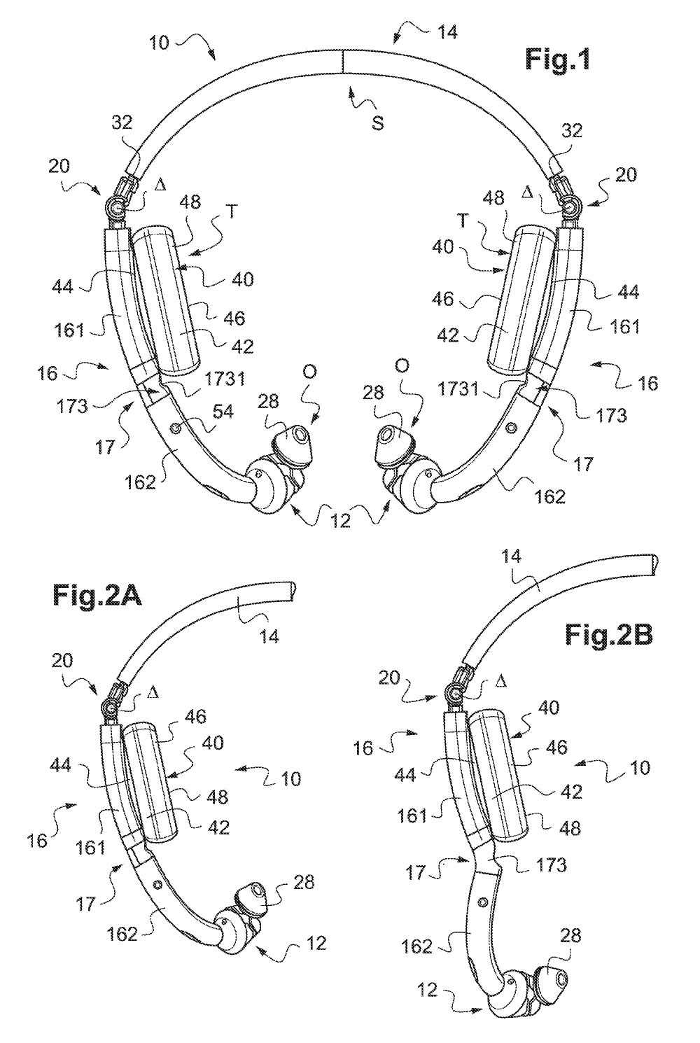

FIG. 1 is a front view of an exemplary embodiment of the headset according to the invention.

FIGS. 2A and 2B are face views of a branch of the headset of FIG. 1, in two different states.

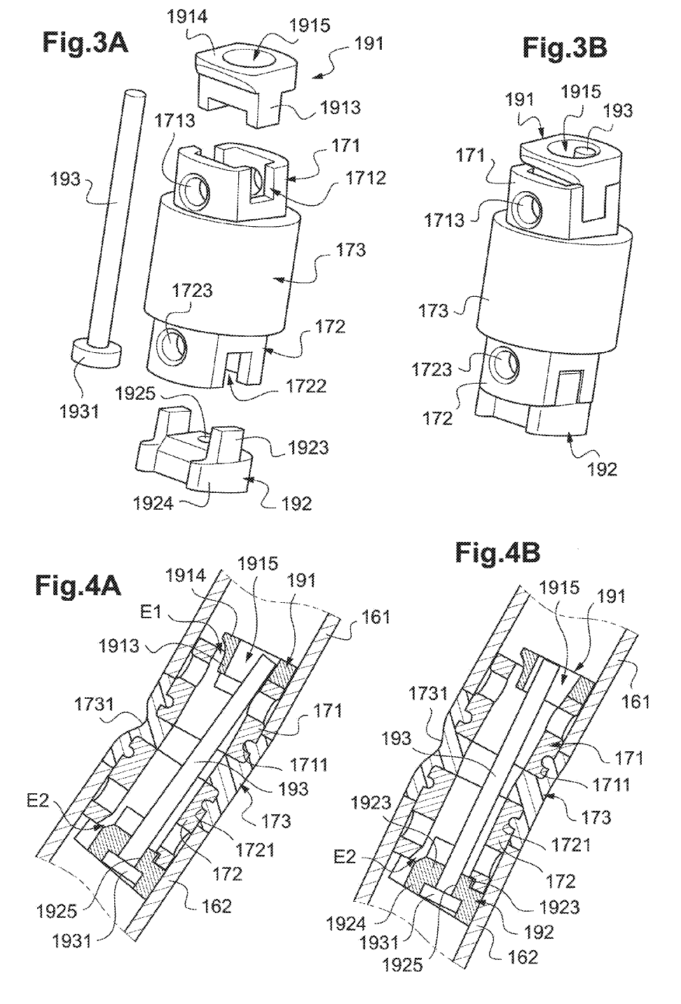

FIG. 3A is an exploded perspective view of a linking portion of the branch of FIGS. 2A and 2B.

FIG. 3B is a perspective view of the linking portion, after assembly.

FIGS. 4A and 4B are axial sectional views of the linking portion of FIGS. 3A and 3B, in two different states.

In the figures, the reference 10 generally denotes an exemplary embodiment of a headset according to the invention, which has two earphones 12 linked by a linking element comprising a central headband 14 and two branches 16.

The earphones 12 are of a so-called “intra-aural” (as in the example illustrated in the figures) or “intra-concha” known type. The intra-aural earphones are those which include a tube entering the auditory canal, this tube ensuring the mechanical holding of the earphone on the ear, whereas the intra-concha earphones are intended to be arranged in the region of the central depression (lower concha) of the external ear located at the exit of the auditory canal.

The two branches 16 with their earphones 12 are similar and symmetrical. Each includes at its proximal end 18 a link 20 articulated to the central headband 14. This articulated link 20 provides at least one pivotal degree of freedom about an axis A perpendicular to the general plane of the headset. It further advantageously includes a spring clamping element, not visible, allowing elastically stressing the branch 16 towards the internal side of the headset in order to stress this branch, and hence the earphone 12, towards the temple and the ear of the user to improve the coupling of the earphone to the ear.

On the distal side, the branch 16 is connected to the earphone 12, preferably rigidly. As an alternative, it may also be used a flexible link made for example by over-molding a deformable matter between the end of the branch 16 and the base of the earphone 12, so as to facilitate the introduction and the holding of the protruding tip 28 of the earphone inside the auditory canal.

It will be noted that the invention is preferably implemented with earphones 12 of the intra-aural type, which provide an increased insulation with respect to the ambient noises due to the protruding tip 28 introduced into the auditory canal. This tip 28 is moreover provided with a deformable piece (not illustrated), for example made of silicone or foam, to ensure a better coupling with the ear and hence a better passive insulation.

The central headband 14 is deformable in bending, i.e, by remaining in the general plane of the headset (the plane of the figure in the case of FIG. 1), for example thanks to an elastic metal blade (not visible), embedded in the matter of the central headset 14. This flexibility allows adapting easily the headset to most of the cranium diameters liable to be met.

Also, to allow an adaptation to the morphology of the different users, it is provided, near the articulated link 20, a telescopic element 32 allowing the distance separating the articulated link 20 of the earphone 12 to be varied, typically up to a maximum extent of the order of 40 mm, so as to be adapted to most of the cranium heights liable to be met.

On the other hand, the region of each branch 16 adjacent to the articulated link supports a respective casing 40 fulfilling several functions that will be explained hereinafter.

Advantageously, the casing 40 is located in the most proximal part 161 of the respective branch 16, which allows in particular folding the headset over itself for storage and transportation.

In this folded position (not illustrated but which can be deduced from FIG. 1), the telescopic elements 32 have been placed in a position of minimum extension, and it remains enough room between the two casings 40 so that the two earphones 12 can take place in-between. In this fully folded position, it is observed that all the voluminous elements of the headset, mainly the two casings 40 and the two earphones 12, are located essentially on a same side of a line connecting the two articulated links 20 on either side of the central headband 14, hence ensuring a maximum compactness.

Each casing 40 is consisted of a body 42 linked to the branch 16 by an element 44, so that the casing 40 can slightly protrude towards the internal side of the headset, towards the user's temple. As a variant, it could however be provided a thicker branch including the casing 40 in a more integrated shape.

The body 42 is closed by a lid 46 provided with a lining forming a bearing face 48, for example a foam lining that ensures a triple function:
good contact with the user's head, the deformation of he foam allowing conforming the profile of the user's temple;
element of comfort at the headset-temple contact; and
sliding resistance, for a better stability in particular with respect to the sudden movements during sport practice.

The casings 40 contain various electric or electronic elements, for example one or several printed circuits boards in one of the casings, or a rechargeable battery in the other casing, the two casings being connected via an electric link (not shown) running through the central headband 30.

The electronic circuits may also possibly be connected to various sensors and/or electrical members supported by the branches 16, for example one or several microphonic sensors 54 for functions of handsfree telephony and/or functions of active noise cancellation ANC by sensing of the ambient noise level, or also an electric connector (not show).

According to the invention, to optimize the headset wearing comfort with a good adaptability to various shapes and sizes of wearers' heads, each branch 16 is made of two portions 161, 162 connected to each other by a flexible link 17.

The two portions 161 and 162 are slightly curved and have herein approximately the same length, the distal portion 162 that extends between the flexible link 17 and the respective earphone 12 however having a greater curvature in the vicinity of the latter to provide a suitable clearance of the earphone towards the inside and a good freedom of engagement into the auditory canal.

We will now describe in details how the flexible link 17 is made, with reference to FIGS. 3A, 3B and 4A, 4B.

This link comprises a first ring 171 and a second ring 172 spaced apart by a distance of typically a few millimeters and on which is fixed an elastically deformable sleeve 173.

The fastening between these three pieces is preferably implemented by over-molding the sleeve 173 onto the rings 171, 172 suitably held in place.

In this case, to ensure the strength of the unit, in particular in traction, it is provided on each of the rings 171, 172 a continuous or discontinuous peripheral groove 1711, 1721, respectively, into which the matter of the sleeve 173 enters to ensure a suitable mutual anchoring.

Each of the rings has a diametrical recess 1712, 1722, respectively, open in the face of the ring that is opposed to the sleeve 172, and a diametrical cylindrical passage 1713, 1723, respectively, oriented transversally to the associated diametrical passage.

In the recess 1712 of the ring 171 is housed a counterpart portion 1913 of a movement limitation piece 191 provided, as shown in FIGS. 4A and 4B, with a conical through-passage 1915 oriented in the axial direction. Above said portion 1913, the piece 191 has a wider portion 1914 that is so dimensioned to leave between it and the internal passage of the ring 171 a lateral space El intended for the passage of conductors (for example, a beam or a web of conductors, not illustrated).

In the recess 1622 of the ring 172 is housed a counterpart portion 1923 of a holding piece 192 provided with a through-passage 1925 provided with a shoulder, oriented in the axial direction. Above said portion 1924, the piece 192 has a wider portion 1924 that is so dimensioned to leave between it and the internal passage of the ring 172 a lateral space E2 intended for the passage of the above-mentioned beam or web of conductors.

The flexible link finally comprises a bending limitation rod 193 of generally cylindrical shape, with a head 1931 at one of its ends.

The different above-mentioned elements are preferably made of a plastic material of suitable physical properties, except the sleeve 173 that is made of an elastically deformable material such as an elastomer, a silicon, a thermoplastic elastomer or a thermoplastic polyurethane, and except, as the case may be, the rod 192, which may be made of a material having a higher rigidity, typically a metal alloy or a reinforced plastic material.

We will now describe the assembly and the behavior of the flexible link, the structural elements of which have just described.

The ring 171 and the movement limitation piece 191, as well as the ring 172 and the holding part 192, are fastened to each other by bonding, ultrasound welding, etc.

Likewise, the bending limitation rod 193 is fastened to the holding piece 192 by being engaged into the through-passage 1925 from below, the head 1931 being received in the widest portion of this passage, and the fastening being made by bonding, ultrasound welding, etc.

The units 171, 191 on the one hand, and 172, 192, 193 on the other hand, are placed so that the free end region of the rod 193 is engaged into the passage 1915 of the piece 191 and held in a geometric relation of general alignment in a mold for the making of the sleeve 173 by over-molding.

The so-made assembly is illustrated in FIGS. 3B, 4A and 4B. FIGS. 4A and 4B also show that the end of the proximal portion 161 of the branch 16 opposed to the articulated link 20 is generally tubular and fits about the ring 171, the fastening being made by bonding, ultrasound welding, etc. As a variant, the portion 161 may be made by over-molding, in which case the passages 1713 allow making, during this over-molding, a cooperation of shapes ensuring an efficient mutual fastening.

Likewise, the end of the distal portion 162 of the branch opposed to the earphone 12 is generally tubular and fits about the ring 172, so as to be fastened to the latter in the same way.

During a suitable mounting phase, the beam or web of conductors which must pass through the flexible link 17 is threaded into the latter via the above-mentioned spaces E1 and E2, these conductors being in particular intended to connect the electronic circuits housed in the casings 40 or in one of them to the respective earphone, to a speech or ambient noise sensing microphone, etc., and extending inside the portions 161, 162 of the branch 16.

The flexible link 17, by being located at an intermediate level of the branch 16, absorbs particularly efficiently the exerted stresses, while transmitting a controlled effort, determined in particular by the elastic properties and the dimensions of the sleeve 173, to the earphone 12 to keep a suitable tightness at the tip 28 thereof.

It will be noted herein that the rod 193 allows limiting the angular bending deformations of the flexible link 17, due to the limitations of displacement of the free end region of said rod in the passage 1915 of the piece 191. This allows on the one hand avoiding a risk of deterioration of the beam or web of conductors passing through the link, which could occur with excessive bending, and on the other hand ensuring that the earphone stays correctly in place, or correctly go back in place if externally stressed, within the auditory canal.

It will also be noted, as well shown in FIGS. 4A and 4B, that the point of fastening of the head 1931 of the rod 193 and the passage 1915 are positioned so as to hold the rod at a remote position from the conductors that will extend through the spaces E1 and E2, and for example out of center with respect to a general axis of the through-openings and of the internal space of the sleeve, so as to limit the risks of deterioration of the conductors during the movements of the rod 193.

The same structure and the same functionalities are found at the opposite branch.

By way of illustration, FIGS. 2A and 2B illustrate one of the branches 16 of the headset, respectively:
in the absence of stress (at rest), in which case the portions 161, 162 of the branch 16 are generally aligned with each other at the link 17,
with an outward stress (exerted for example due to the wearer's morphology), in which case the portion 162 of the branch 16 is outwardly spaced apart, in the limits allowed by the bending limitation function, with respect to the portion 161.

It will be noted herein that, by acting on the geometry of the sleeve 173, it is possible to provide the flexible link with a privileged deformability in such or such bending direction.

In this individual case, and as illustrated in particular in FIGS. 2A, 2B, 3A and 3B, a notch 1731 formed in the external wall of the sleeve and turned towards the inside of the headset (towards the wearer's temple) allows creating a privileged bending direction in the frontal plane of the wearer, or approximately in this plane.

A particularity of the just described headset configuration is that it has five points of contact with the user's head, i.e., as illustrated in FIG. 1:
a point S where the central headband 14 is in contact with the cranium apex;
two points T where the bearing faces 48 of the casings 40 are in contact with the lateral portions of the cranium, in the temporal or parietotemporal region;
two points O where the earphones 12 are in contact with the auditory canal into which the tip 28 is inserted.

It is hence provided, characteristically of the invention, a holding of the “head-temple-ears” type which both: i) guarantees a perfect stability of the headset, in particular during the practice of a sport activity, and ii) ensures a very good comfort, even during a prolonged wearing and/or in a relatively high temperature ambiance, because the ear auricle and the major part of the user's head (with the limited exception of the five points of contact) stay aerated and ventilated to allow in particular the evacuation of sweat.

In this individual case, the stability is ensured jointly by first controlled elastic stresses at the articulated links 20, and by second controlled elastic stresses at the intermediate flexible links 17.

1. An audio headset, comprising:
two earphones (12) of the intra-aural or intra-concha type, adapted to be introduced inside or near a respective auditory canal of the headset user;
a central headband (14) adapted to come in rest on the apex of the headset user's head so as to form thereon a first point of contact with the user's head; and
two lateral branches (16) continuing the central headband at each of the ends thereof, each of the branches comprising:
at a proximal end of the branch, a link (20) articulated with the respective end of the central headband (14), p2 this link providing at least one pivotal degree of freedom about an axis perpendicular to the general plane of the headset, and the respective earphone being mounted at the distal end of the branch, the earphones forming at the auditory canal a second and a third point of contact, respectively; and
in a median region of each branch, a respective bearing pad (40) provided, on an internal side of the headset directed towards the user's head, with a bearing face (48) adapted to come into contact with a temporal region of the headset user, so that the bearing faces form at the temple a fourth and a fifth point of contact, respectively,
characterized in that said branches (16) each have, in an intermediate region between a proximal end on the central headband side and a distal end on the earphone side, an elastically deformable link (17).

2. The audio headset of claim 1, wherein each elastically deformable link (17) is located substantially at mid-length of the respective branch.

3. The audio headset of claim 1, wherein the earphones (12) are mounted rigidly on the distal ends of the respective branches (16).

4. The audio headset of claim 1, wherein each elastically deformable link (17) has a torsional degree of freedom and at least one flexural degree of freedom.

5. The audio headset of claim 1, wherein each elastically deformable link comprises two spaced-apart pieces (171, 172) integral with two branch portions (161, 162) located on either side of the link, and an elastically deformable sleeve (173) anchored on said pieces.

6. The audio headset of claim 5, wherein each piece (171, 172) and the sleeve (173) have parts (1711, 1721) of mutual shape cooperation.

7. The audio headset of claim 5, wherein said pieces (171, 172) each have the shape of a ring provided with a through-opening and the elastically deformable link (17) comprises a bending limitation element (193) extending through said through-openings and the internal space of the sleeve.

8. The audio headset of claim 7, wherein the bending limitation element comprises a rod (193) made of a material that is more rigid than that of the sleeve, fixed at one end to one (172) of the rings, to the other ring (171) being associated a cavity (1915) adapted to receive the free end of the rod and limiting the displacements thereof

9. The audio headset of claim 8, wherein said cavity (1915) is adapted to hold the rod at a remote position from a trajectory of passage of electric conductors (E1, E2) defined by the rings (171, 172).

10. The audio headset of claim 1, wherein the elastically deformable link comprises means (1731) to ensure a privileged bending of said link in a particular plane.

11. The audio headset of claim 10, wherein each elastically deformable link comprises two spaced-apart pieces (171, 172) integral with two branch portions (161, 162) located on either side of the link, and an elastically deformable sleeve (173) anchored on said pieces.

12. The audio headset of claim 11, wherein the means comprise a notch (1731) formed in an external wall of the sleeve (173).
